(19) United States
(12) Patent Application Publication
(10) Pub. No.: US 2026/0007137 A1
(43) Pub. Date: Jan. 8, 2026

(54) FRESHNESS ENHANCING LABELS, SHEETS, AND SACHETS

(71) Applicant: Ryp Labs, Inc., Bothell, WA (US)

(72) Inventors: Ahmed SOLIMAN, Kirkland, WA (US); Steven John HULTENG, Mukilteo, WA (US); Ozgur Emek YILDIRIM, Bellevue, WA (US); Benjamin Grady JONES, Issaquah, WA (US); Michael McCutcheon JOHNSON, Tacoma, WA (US); Katherine BENOIT, Bellevue, WA (US); Davis E.W. WEBB, Snohomish, WA (US); John B. HARMON, IV, Seattle, WA (US)

(73) Assignee: Ryp Labs, Inc., Bothell, WA (US)

(21) Appl. No.: 19/111,708

(22) PCT Filed: Sep. 15, 2023
(86) PCT No.: PCT/US2023/074290

§ 371 Date: Mar. 13, 2025

Related U.S. Application Data
(60) Provisional application No. 63/376,045, filed on Sep. 16, 2022.

(51) Int. Cl. A23B 2/721; A23B 7/152; B32B 7/06; B32B 7/12; B65D 81/28

(52) U.S. Cl. CPC A23B 2/721; A23B 7/152; B32B 7/06; B32B 7/12; B65D 81/28; B32B 2439/70

(57) ABSTRACT

Freshness enhancing labels, sheets, and sachets are presented. In one embodiment, a sachet for preventing spoilage of a perishable good includes one or more composites, where each composite of the one or more composites includes one or more bioactive compound and a carrier material, and a transmitting layer configured to enclose the composite and allow the transmission of the one or more bioactive compounds. Further, a sheet for preventing spoilage of a perishable good includes one or more composite, where each composite of the one or more composites comprises one or more bioactive compound and a carrier material, and a substrate configured to hold the composite, where the sheet is configured to transmit the one or more bioactive ingredients onto the perishable good.

### CROSS-REFERENCE TO RELATED APPLICATION

This application claims the benefit of U.S. Provisional Application 63/376,045, filed Sep. 16, 2022, the entire disclosure of which is hereby incorporated by reference.

### BACKGROUND

Various volatile compounds like essential oil compounds are known to have antifungal activity and can help extend shelf lives of perishable goods by inhibiting spoilage. Preventing spoilage over a certain duration of time requires that the compounds are released to the environment in a continuous and predictable manner so as to maintain the desired concentrations of these volatile compounds in a gas phase. In addition to volatile compounds with antifungal activity, other volatile compounds, like 1-MCP as utilized in the environment of perishable goods like climacteric fruits, can act in tandem in order to extend the shelf life of perishable produce.

Accordingly, systems and methods for controlling the release rate of an active compound to prolong the shelf life of a perishable good are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a sachet for preventing spoilage of a perishable good includes one or more composites, where each composite includes one or more bioactive compound and a carrier material, and a transmitting layer configured to enclose the composite and to allow the transmission of the one or more bioactive compounds.

In another aspect, a sheet for preventing spoilage of a perishable good includes one or more composites, where each composite of the one or more composites includes one or more bioactive compounds and a carrier material, and a substrate configured to hold the composite, where the sheet is configured to transmit the one or more bioactive ingredients onto the perishable good.

In yet another aspect, a layer of adhesive is added to the sheet to form a label or sticker configured to be secured to the inside or the outside of a container.

In yet another aspect, a system includes a container and at least one of the sachet, sheet, label, or sticker as described herein.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1M are example sachets, in accordance with the present disclosure;

FIGS. 2A-2B are example sachets with an adhesive backing, in accordance with the present disclosure;

FIGS. 3A-3D are example sheets, in accordance with the present disclosure;

FIGS. 4A-4C are example stickers, in accordance with the present disclosure;

FIGS. 5A-5D are example stickers, in accordance with the present disclosure;

FIGS. 6A-6C are example configurations for products, in accordance with the present disclosure;

FIG. 7 is an example container with a label, in accordance with the present disclosure; and

FIG. 8 is an example method of forming products, in accordance with the present disclosure.

### DETAILED DESCRIPTION

While illustrative embodiments have been illustrated and described, it will be appreciated that various changes can be made therein without departing from the spirit and scope of the invention.

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those skilled in the art that variations may be applied to the articles and/or methods and in the steps or in the sequence of steps of the method described herein without departing from the concept, spirit, and scope of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one”, but it is also consistent with the meaning of “one or more”, “at least one”, and “one or more than one”. The use of the term “or” is used to mean “and/or” unless explicitly indicated to refer to alternatives only if the alternatives are mutually exclusive, although the disclosure supports a definition that refers to only alternatives “and/or”. Throughout this application, the term “about” is used to indicate that a value includes the inherent variation of error for the quantifying device, the method being employed to determine the value, or the variation that exists among the study subjects. For example, but not by way of limitation, when the term “about” is utilized, the designation value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Postharvest spoilage of fruits, vegetables and plants is a cause of significant economic loss. Certain volatile essential oil compounds (also referred to as “bioactive compounds,” “compounds,” or “formulations”) possess bioactive properties that help protect perishable produce from spoilage. When these bioactive compounds are released into the environment where the perishable produce is stored, the post-harvest losses due to spoilage can be reduced. The formulations can include one or more such active compounds that suppress spoilage by limiting microbial growth. The formulations can also include compounds with other important functions such as those that preserve and stabilize the active compounds (such as antioxidants), compounds that help create a desirable aroma profile, those that can modulate the ethylene response, and those that stimulate and modulate the natural defenses/immune responses of the produce. Finally, such ingredients can also be combined with various carrier and controlled release matrices such as waxes. These formulations, or composite formulation-carrier combinations constitute a platform that perform the core functions affecting the biological response.

These composites can be further incorporated into various integrated final products as described herein. This disclosure describes a number of product concepts suitable for use in retail boxes such as clamshells containing fruits, closed containers, salad boxes, or boxes of fruits, trays and bags such as salad bags or fruit bags. The term “product” should be understood to include sachets, stickers, labels, sheets, and combinations thereof as described herein.

In one aspect, a sachet for preventing spoilage of a perishable good including one or more composites, where each composite of the one or more composites includes one or more bioactive compounds and a carrier material. The sachet also includes a transmitting layer configured to enclose the composite and allow the transmission of the one or more bioactive compounds.

In some embodiments, the one or more composites are in the form of beads, granules, powders, disks, sheets, flakes, or a combination thereof.

In some embodiments, the bioactive compound is selected from a group consisting of trans-2-hexenal, trans-2-octenal, trans-2-nonenal, trans-2-decenal, trans-2-dodecenal, cuminaldehyde, citronellal, thymol, perillaldehyde, carvacrol, citral, carvone, pulegone, eugenol, bornyl acetate, 1-octanol, terpinen-4-ol, linalool, trans-anethole, trans-cinnamaldehyde, ethyl octanoate, ethyl nonanoate, ethyl decanoate, methyl octanoate, methyl nonanoate, methyl decanoate, fenchol, borneol, camphor, methyl eugenol, menthol, methyl salicylate, methyl anthranilate, phenylethyl acetate, phenylacetic acid, cinnamic acetate, gamma-octalactone, gamma-decalactone, eucalyptol, geranium oil, lavender oil, thyme oil, clove oil, (−)-bornyl acetate, (−)-terpinen-4-ol, (+)-carvone, (+)-citronellal, (R)-(+)-citronellal, (S)-(−)-citronellal, (R)-(+)-pulegone, thymol, 4-allylanisole, cis-3,7-dimethyl-2,6-octadien-1-ol, citronellol, methyl trans cinnamate, myrcene, ocimene, terpineol, 1-methyl-3-methoxy-4-isopropylbenzene, menthol, menthone, isomenthone, vanillin, geranyl formate, palmitic acid, (S)-(−)-perillaldehyde, nootkatone, hinokitiol, d-limonene, s-limonene, p-cymene, nerolidol, 3-decen-2-one, and other stereoisomers of these compounds, and combinations thereof. In some embodiments, the carrier material is selected from the group consisting of water, paraffin, petroleum waxes, natural waxes, beeswax, resin, synthetic polymer, biodegradable natural polymer, ceramic, modified cellulose, methyl cellulose, surfactants, mesoporous silica nanoparticles, microporous alumina, anodized aluminum, activated carbon, zeolites, metal carboxylates, inorganic compounds, and combinations thereof.

In some embodiments, the sachet further includes a peel-away layer, an adhesive layer configured to secure the sachet to a surface, and a backing layer configured to contact the adhesive layer. In some embodiments, the backing layer is permeable to the one or more bioactive compounds. In some embodiments, the adhesive layer is mixed or infused with the one or more bioactive compounds. In some embodiments, the peel-away layer may be on one or more faces of the sachet, including a front-side, a back-side, a left-side, and/or a right side of the sachet. In some embodiments, the peel-away layer(s) is configured to protect the adhesive layer until the sachet is ready to be applied. In some embodiments, the peel-away layer traps the bioactive compounds inside the sachet (or sheet as described herein). In such embodiments, the release of the bioactive compounds starts once the peel-away layer is peeled away and/or removed.

In another aspect, a sheet for preventing spoilage of a perishable good includes one or more composites, where each composite of the one or more composites includes one or more bioactive compounds and a carrier material, and a substrate configured to hold the composite, where the sheet is configured to transmit the one or more bioactive ingredients onto the perishable good is disclosed. In some embodiments, the sheet may include an adhesive layer. In some embodiments, the sheet may be referred to as a “label” or “sticker”. One skilled in the art should understand that a sheet with an adhesive backing is considered a label or a sticker as described herein.

In some embodiments, the one or more composites is coated onto the substrate. In some embodiments, the one or more composites at least partially impregnate the substrate. In some embodiments, one or more composites are sandwiched between layers of a sheet or sachet. In some embodiments, the one or more composites are embedded between layers of the sheet or sachet.

In some embodiments, the sheet further includes an adhesive layer configured to secure the sheet to the container, and a peel-away layer configured to be removed from the adhesive layer to expose the adhesive layer. In some embodiments, the adhesive layer is mixed or infused with the one or more bioactive compounds.

In some embodiments, the sheet further comprises a topcoat layer configured to adjust the release rate of the one or more bioactive compound. In some embodiments, the topcoat layer further includes the one or more bioactive compounds. In some embodiments, the sheet further includes a peel-away top layer configured to protect the adhesive layer until the sachet is ready to be applied. In some embodiments, the peel-away top layer traps the bioactive compounds inside the sheet. In such embodiments, the release of the bioactive compounds starts once the peel-away layer is peeled away and/or removed.

In some embodiments, the sheet is configured for securing to the outside of the container. In some embodiments, the sheet further includes a top layer configured to prevent loss of the one or more bioactive ingredients into the environment.

In some embodiments, the top layer comprises an image, infographic, text, or a combination thereof.

In some embodiments, a system for preventing spoilage of a perishable good includes the sachet described herein and a container, where the sachet is placed inside the container and is configured to release the one or more bioactive ingredient into the container and onto the perishable good.

In some embodiments, a system for preventing spoilage of a perishable good includes the sheet described herein, and a container configured to hold a perishable good, where the sheet is placed inside the container and configured to release the one or more bioactive ingredient into the container and onto the perishable good.

In some embodiments, a system for preventing spoilage of a perishable good including a sheet as described herein, and a permeable container, where the sheet is placed on the outside of the permeable container, and wherein the sheet is configured to release the one or more bioactive compounds through the permeable container and onto the perishable good is disclosed. In some embodiments, the permeability of the container can be achieved through material choice (such as the chemistry of the container), the thickness, and/or with physical patterns (such as making perforations in the container). In some embodiments, the permeable container is completely permeable, that is, all surfaces of the container are permeable. In some embodiments, the permeable container includes a permeable portion that is not the entire surface of the container.

In general, sachets, sheets, labels or other products for preventing spoilage of a perishable good may be collectively referred to as “spoilage preventing products.” These spoilage preventing products include one or more composites, where each composite of the one or more composites includes one or more bioactive compounds and a carrier material.

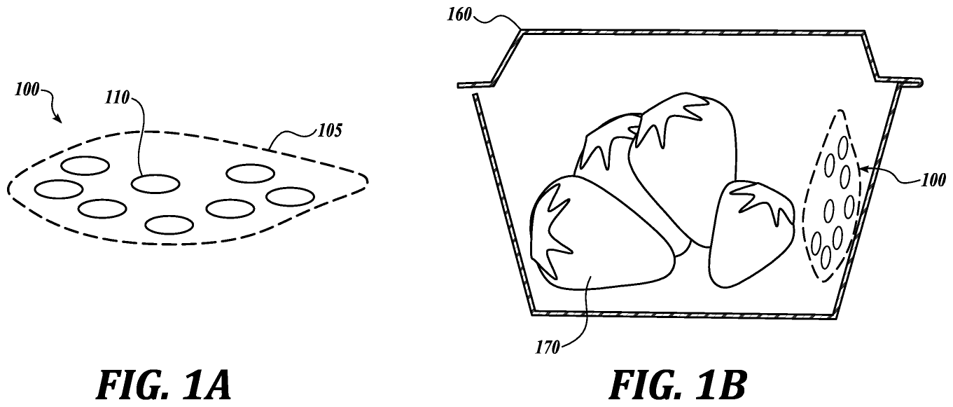

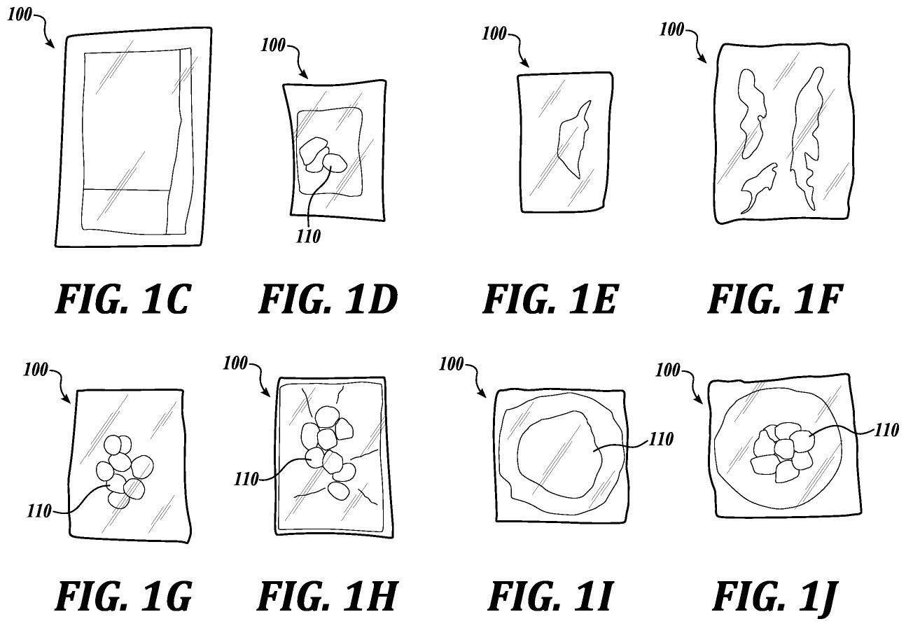

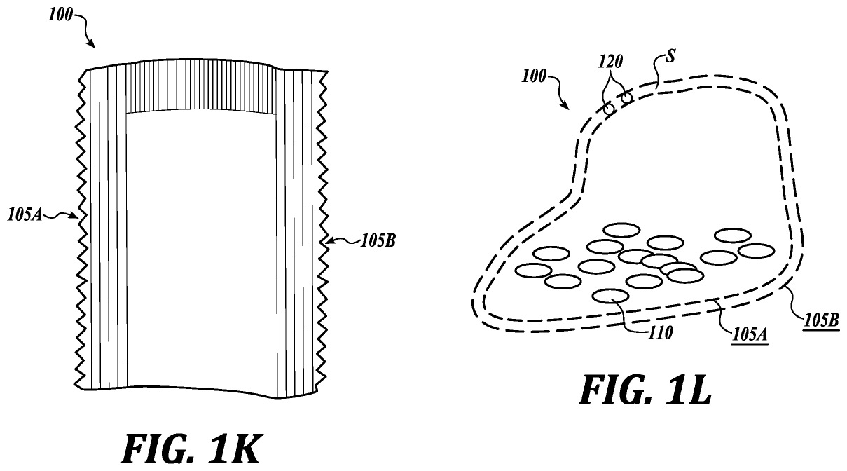

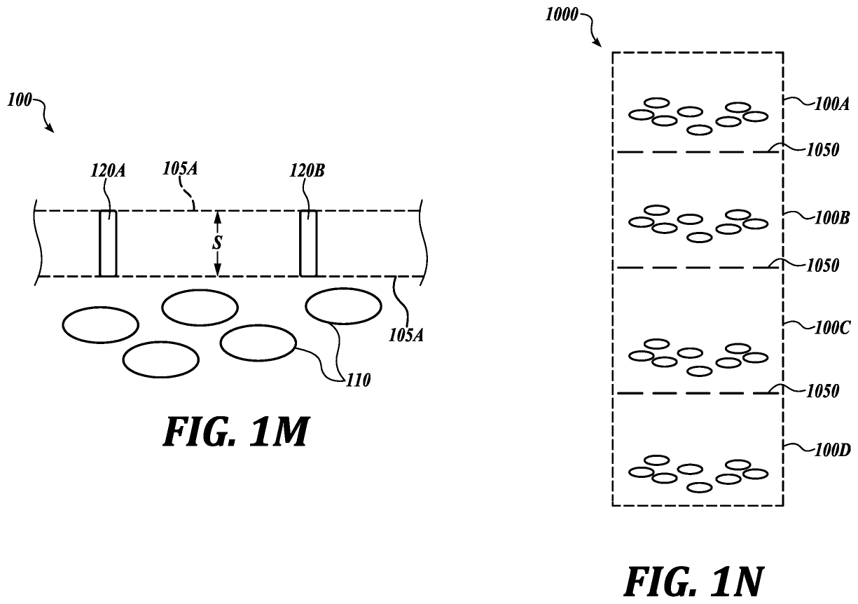

FIGS. 1A-1M are example sachets 100, in accordance with the present disclosure. In some embodiments, the carrier-active compounds as described in detail herein are incorporated into a sachet 100, as shown in FIGS. 1A-1M.

In some embodiments, the sachet 100 includes one or more composites 110 (or composite formulations), where each composite of the one or more composites includes one or more bioactive compounds and a carrier material, and at least one transmitting layer 105, which may be a sheet, or both.

In some embodiments, the transmitting layer 105 is made of a cellulose material, a permeable mesh, paper, plastic, or nylon. In some embodiments, the transmitting layer is sealed with glue. In operation, the transmitting layer contains the carrier active compounds 110 (or composite formulations) and is permeable to allow the bioactive compounds to be transmitted through the transmitting layer 105.

The composite formula 110 can take any number of forms, including beads, granules, powders, disks, sheets, and combinations thereof, as described in further detail herein. In some embodiments, discrete pieces of the composite formula 110 can each contain a blend of bioactive compounds. In some embodiments, different groups of composite formulation 110 particles can contain different groups of bioactive compounds.

In some embodiments, an anticaking or anticlumping agent, such as cornstarch, potato starch or other starches, cellulose powder, amylopectin, maltodextrin, silicon dioxide, magnesium silicate, calcium silicate, calcium carbonate, sodium bicarbonate, diatomaceous earth, bentonite and other clays is added to the granules of composite 110 to prevent them from sticking together and clumping.

In some embodiments, the sachet further includes one of more compounds configured to offset, neutralize, or complement the scent of the one or more bioactive compounds. In some embodiments, the one or more compounds is one or more furaneols (such as strawberry furanone, maple furanone, or caramel furanone), methyl cinnamate, methyl butyrate, propyl heptanoate, hexyl cinnamate, methyl anthranilate, methyl jasmonate, nonadienal, or a combination of compounds.

In some embodiments, the sachet 100 is a pouch, or a bag with an approximate size of a teabag. In some embodiments, the sachet 100 is larger, such as the size of a diaper. The sachet 100 is made of two sheets 105A, 105B with a space between them, or a pouch that contains the composite formulation 110. In some embodiments, sachets 100 are thicker and can be uneven with a slight bulge near the middle. Sachets 100 may be placed in the use environment as a loose drop-in. The solid formulation composites 110 placed inside the sachets can be in the form of tablets, flakes, beads, pellets, granules, powders, etc. As shown in FIG. 1B, the loose sachet 110 can then be placed into a container 160 with a perishable good 170.

In some embodiments, the container 160 is a clamshell container, such as illustrated in FIG. 1B, but the container 160 may take any number of forms, including a bag, a box, a carton, and the like.

When the sachet 100 is placed inside the container 160, the transmitting layer (such as sheets 105A, 105B, or both) allows for the bioactive compound 110 inside the carrier to be transmitted to the perishable good 170, thereby preserving it, preventing contamination, postponing spoilage, and the like. FIGS. 1C-1J show a plurality of forms that the sachet 100 may take. In some embodiments, the permeability of the transmitting layer(s) is based on the material choice (or the chemistry of the transmitting layer) and/or physical patterning, ushc as including micro perforations.

As illustrated in FIGS. 1C-1J, the sachet 100 can take any form or shape, including round and rectangular. The sachet 100 may be clear or opaque, and can be made of any sort of materials, including plastic, paper, nylon, and the like.

In some embodiments, such as shown in FIG. 1K, the sachet 100 may include one or more perforated edges 1050A, 1050B.

In some embodiments, the sachet 100 may include a transmitting layer 105 containing the composite formula 110, such as shown in FIG. 1L. In some embodiments, the transmitting layer 105 may be rigid. In some embodiments, the transmitting layer 105 may be formed wet and dry into a rigid material, like paper mâché. In some embodiments, the sachet 100 may include a rigid transmitting layer formed to fit within a container (such as container 160) or to fit within a specific shape, size, or configuration of a container. In some embodiments, the rigid sachet 100 can be designed to have a specific shape, for example, the fit a corner of the packaging where the sachet 100 is placed. In some embodiments, the transmitting layer 105 may have two layers 105A, 105B, with space S between the two layers. In some embodiments, the space S includes supports 120. In some embodiments, the supports 120 are corrugation.

FIG. 1M shows a side view of sachet 100 with two transmitting layers 105A, 105B. In some embodiments, there is a space S between the two transmitting layers 105A, 105B. In some embodiments, the space S is created with one or more supports 120A, 120B. In some embodiments, the one or more supports 120A, 120B are corrugation.

As shown in FIG. 1N, in some embodiments, the sachets 100A, 100B, 100C may be formed or manufactured in a roll 1000. In some embodiments, the roll 1000 includes perforations (or markings) 1050A, 1050B, 1050C, 100D demarcating individual sachets 100A, 100B, 100C, 100D. In some embodiments, the sachets 100A, 100B, 100C, 100D may be torn or cut apart at the perforations (or markings) 1050A, 1050B, 1050C, 100D.

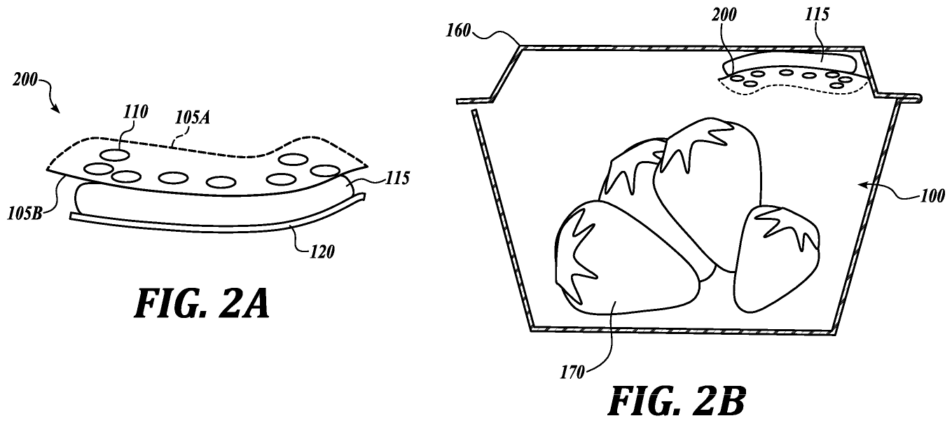

FIGS. 2A-2B are example sachets 200 with an adhesive layer 115, in accordance with the present disclosure. In some embodiments, a sachet 200 further includes a backing layer 105B, an adhesive layer 115, and a peel-away layer 120, such as shown in FIG. 2A.

As shown in FIG. 2A, the backing layer 105B is configured to contact the adhesive layer 115. In some embodiments, either sheet 105A, 105B, or a combination thereof, may be a backing layer 105B. The backing layer 105B may be permeable or impermeable to the bioactive compounds 110. In some embodiments, the backing layer 105B is made of the same materials as the transmitting layer (such as sheet 105A).

In some embodiments, the adhesive layer 115 is a coating of adhesive, a dollop of adhesive, or a double-sided tape. In some embodiments, the adhesive may be mixed with or infused with one or more bioactive compounds. In such embodiments, the adhesive also functions as a carrier and a controlled release matrix for the bioactive compounds 110. In some embodiments, the adhesive may contain one or more compounds as described herein.

In some embodiments, the peel away layer 120 is plastic, paper, or nylon, and protects the adhesive from contamination prior to placement. In operation, a user peels off the peel away layer 120 and attaches the sachet 200 to a container 160, such as shown in FIG. 2B. In some embodiments, the peel-away layer may be on one or more faces of the sachet, including a front-side, a back-side, a left-side, and/or a right side of the sachet. In some embodiments, the peel-away layer(s) is configured to protect the adhesive layer until the sachet is ready to be applied. In some embodiments, the peel-away layer traps the bioactive compounds inside the sachet (or sheet as described herein). In such embodiments, the release of the bioactive compounds starts once the peel-away layer is peeled away and/or removed.

In some embodiments, the sachet 200 includes a plurality of topcoat layers, each configured to further affect the release rate of the bioactive compounds. Topcoat layer(s) can also function as protective layers to reject various compounds from the outside and stop them from getting to the inner layers of the carrier containing active compounds. For example, they can serve as moisture, humidity or oxygen barriers, to protect the active compounds from oxidative or similar damage. Furthermore, they can also help reduce the amount of light reaching the active compounds including UV and help reduce chemical degradation that may be accelerated by various wavelengths of light. In some embodiments, the topcoat layers are on one side of the sachet, but they may also be on both sides of the sachet.

In some embodiments, the sachet 200 may further include an image, an infographic, text, or the like.

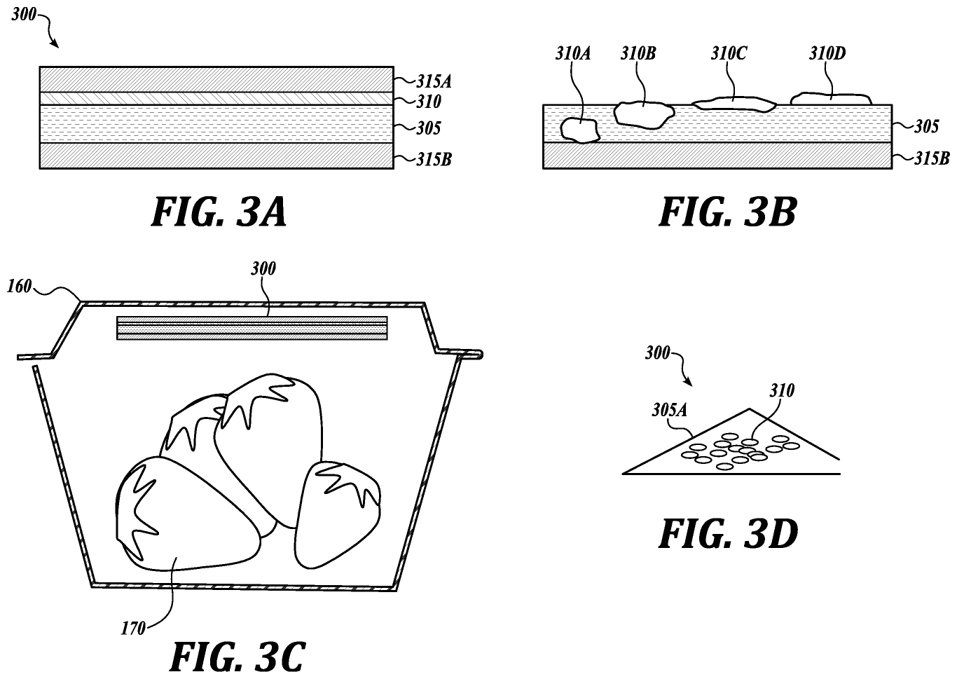

FIGS. 3A-3D are example sheets 300, in accordance with the present disclosure. In some embodiments, the carrier compounds 310 are incorporated into a sheet 300. In some embodiments, the sheet 300 includes multiple laminated layers that are generally planar with a roughly uniform thickness. The resulting product is largely planar and is much wider than it is thick. Sheets 300 can be of different sizes and be placed loose inside the packaging above, under, in between, or on the sides of the produce in the container.

In some embodiments the sheets 300 can be further padded with soft layers around them to cushion and protect the co-packed fruits from mechanical damage or bruising. Additional functional components can also be included in this pad, such as components that absorb excess moisture, or absorb ethylene, or degrade ethylene, or release 1-MCP to block ethylene signaling. Examples of ethylene degraders include permanganate such as potassium permanganate.

FIG. 3A shows an example sheet 300 with the carrier composite 110, in accordance with the present technology. In some embodiments, the sheet 300 includes a substrate 305. In some embodiments, the substrate 305 has multiple layers, but the substrate can also be a single layer. In some embodiments, the substrate 305 is made of paper, but the substrate 305 may take any number of forms, including plastic, nylon, or a porous material, such as a sponge.

In some embodiments, the sheet 300 includes one or more capping layers 315A, 315B on the top and bottom planes of the sheet 300. In operation, these capping layers 315A, 315B may prevent water damage or other degradation of the composite carrier 310, the substrate, or both. The capping 315A, 315B layers may also prevent contamination, prevent or retard transmission of the bioactive compounds in the composite 310, or aid or modify the transmission of the bioactive compounds 310 in the composite.

In some embodiments, the sheet 300 is a loose insert that can be placed above, below or on the sides of the product. The sheet 300 can be of any size ranging from a 1 cm by 1 cm size, up to the maximum size allowed by the packaging or container.

In some embodiments, the sheet 300 thickness ranges from about 0.2 mm to about 3 mm thick. In some embodiments, the multilayer substrate 305 can range from about 1-3 mm thick. In some embodiments, the substrate 305 further comprises padding. In some embodiments, the padding ranges from about 1-10 mm thick. In some embodiments, the capping layers 315A, 315B are the padding.

The padding can have other features such as cushioning to protect the fruits from mechanical damage. The padding can also include other functional components, for example, additional bioactive compounds. Furthermore, the outermost layers may be enclosed in a film that is permeable to all the bioactive compounds that need to be transported or transmitted to the perishable good. In some embodiments, the sheet and/or sachet can include an impermeable peel-away layer on the outside surface(s) configured to be removed to commence the release of the one or more compounds.

In some embodiments, the sheet 300, the substrate 305, the compositions 310, the padding, or a combination of components can include one or more compounds as described herein.

In some embodiments, the carrier composite 310 is coated onto the substrate 305 in a layer. In some embodiments, the carrier composite 310A, 310B, 310C, 310D is infused into the substrate 305, as shown in FIG. 3B.

In some embodiments, the bio-active compounds, the carrier, or both (in the form of composite 310), can be absorbed (or impregnated) into the substrate 305. In some embodiments, the active compound is coated and stays on the surface of the substrate 305. In some embodiments, the active compounds 310A, 310B, 310C, 310D may be coated on the surface, but also may impregnate the substrate simultaneously. In some embodiments, a combination of impregnation and coating may be present in the sheet, as shown in FIG. 3B. In some embodiments, each composite 310 of the plurality of composites may contain more than one bioactive compound. In some embodiments, each composite 310 may contain a bioactive compound distinct from the other composites. In this manner, each composite 310 can contain a single bioactive compound or one or more blends of bioactive compounds. In some embodiments, the composite 310 is coated onto the substrate 305, and heat is applied to melt the composite 310, allowing the composite 310 to penetrate the substrate. In some embodiments, the composite 310 includes a solvent that liquifies the composite allowing it to wick into and penetrate the substrate 305. In some embodiments, the solvent subsequently evaporates leaving higher viscosity (thicker) composite liquid, or solidified composite infused into the substrate 305.

In some embodiments, the sheet 300 includes a plurality of topcoat layers, each configured to further affect the release rate of the bioactive compounds. Topcoat layer(s) can also function as protective layers to reject various compounds from the outside and stop them from getting to the inner layers of the carrier containing active compounds. For example, they can serve as moisture, humidity or oxygen barriers, to protect the active compounds from oxidative or similar damage. Lastly, they can also help reduce the amount of light reaching the active compounds including UV and help reduce chemical degradation that may be accelerated by various wavelengths of light. In some embodiments, the topcoat or plurality of topcoats are located on a single side of the sheet 300, but in other embodiments, the top coats are on both sides of the sheet.

In some embodiments, the sheet 300 may be folded or otherwise manipulated to form a shape, such as shown in FIG. 3D. In some embodiments, the sheet 300 may include a transmitting layer (or carrier layer) 305 that is folded over or otherwise manipulated to contain the composite compounds 310. In some embodiments, a sachet (such as sachet 100 as described and illustrated herein) could be placed inside the folded sheet 300. In such embodiments, the folded sheet 300 may be an enclosure for the sachet. In some embodiments, a puck of one or more composites may be placed inside the folded sheet 300.

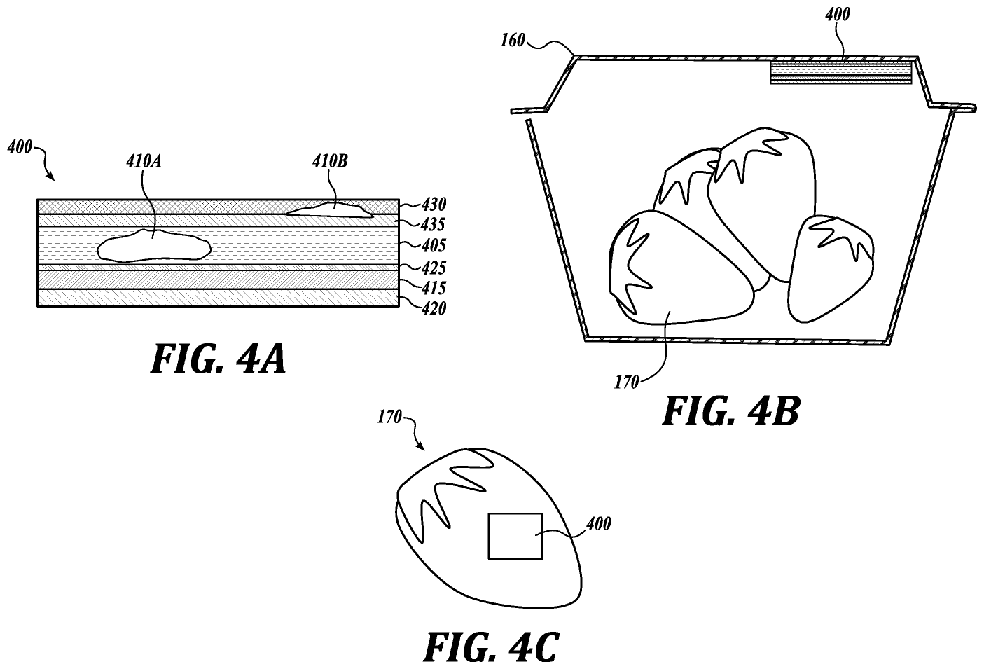

FIGS. 4A-4C are example stickers 400, in accordance with the present disclosure.

In another embodiment, the composite 410 can be incorporated into a sticker 400 (also referred to herein as a label). In such embodiments, the sticker 400 includes a substrate 405 (or carrier layer), an adhesive layer 415, a peel away layer 420, a capping layer 435, and a topcoat layer 430. In some embodiments, the sticker further includes a backing layer 425.

In some embodiments, the sticker 400 includes a carrier layer 405. In some embodiments, the carrier layer 405 may be permeable. In some embodiments, the active compounds 410B are coated onto the carrier layer. In other embodiments, the active compounds 410A permeate the carrier layer. In some embodiments, the bioactive compounds (or the composite) 410A, 410B both permeate and are coated onto the carrier layer 405, such as described herein.

In some embodiments, the sticker 400 further includes an adhesive layer 415. In some embodiments, some or all of the bioactive compounds 410A, 410B may be infused or mixed with the adhesive layer 415.

In some embodiments, the sticker 400 further includes a peel-away layer 420 configured to protect the adhesive 415, and to be peeled off when sticking the sticker 400 to a surface or container 160 or directly onto fruit 170.

Optionally, the sticker 400 may also include a backing layer 425, which may be permeable or impermeable to the transmission of bioactive compounds 410A, 410B.

In some embodiments, the sticker 400 further includes one or more additional compounds as described herein. In some embodiments, the one or more additional compounds are in or on the substrate 405, in the adhesive 415, in the backing layer 425, or some combination of locations.

In some embodiments, the sticker 400 may also include a capping layer 435. In operation, the capping layer 435 may prevent water damage or other degradation of the composite carrier 410, the substrate 405, or both. The capping layer 435 may also prevent contamination, prevent or retard transmission of the bioactive compounds in the composite 410, or aid or modify the transmission of the bioactive compounds 410 in the composite.

In some embodiments, the sticker 400 is made entirely of translucent materials, such that the sticker 400 is not apparently visible when attached to a translucent container 160.

In some embodiments, the sticker 400 further includes a topcoat layer 430. In some embodiments, the topcoat layer 430 has an additional compound dissolved or dispersed within it. In some embodiments, these may be the same bioactive compounds as in the carrier layer 405, different bioactive compounds than those in the carrier layer 405, or a combination. In some embodiments, the topcoat layer 430 is permeable to the bioactive compounds 410A, 410B. In operation, the topcoat layer 430 is configured to act as a physical protection or cap layer 435, as well as a diffusion barrier. In some embodiments, the topcoat layer 430 is further configured to affect the release rate of the bioactive compounds 410A, 410B including slowing down the release rate. The permeability of the active compounds 410A, 410B through these diffusion barrier layers can be modulated by material properties of the diffusion barriers, thicknesses of the diffusion barriers, or by inclusion of patterns such as small perforations in the diffusion barriers. In some embodiments, the sticker 400 includes a plurality of topcoat layers 430, each configured to further affect the release rate of the bioactive compounds. Topcoat layer(s) 430 can also function as protective layers to reject various compounds from the outside and stop them from getting to the inner layers of the carrier containing active compounds. For example, they can serve as moisture, humidity or oxygen barriers, to protect the active compounds from oxidative or similar damage. Lastly, they can also help reduce the amount of light reaching the active compounds including UV and help reduce chemical degradation that may be accelerated by various wavelengths of light.

In operation, the peel-away layer 420 is removed to expose the adhesive. The adhesive 415 is then secured to a surface or container. In some embodiments, the adhesive layer contains the one or more bioactive compounds in the sheet or sachet, and removing the peel-away layer allows for transmission of the one or more bioactives. In some embodiments, the peel-away layer 420 is located on the top of the sticker 400, such as above top-coat layer 430. In some embodiments, the peel-away layer 420 is located at both the bottom and the top of the sticker 400. The topcoat layer 430 allows for the bioactive compounds 410A, 410B to be transmitted to the perishable good 170. In some embodiments, the topcoat layer 430 further alters the release mechanism of the bioactive compounds 410A, 410B, such as by slowing the release rate of the bioactive compounds 410A, 410B.

In cases where the labels (or stickers) 400 are applied on the insides of see-through packaging and the adhesive 415 used is also see through, various artwork, graphics or product information infographics can also be included in the label 400.

In some embodiments, the sticker 400 is configured to attach to the outside of a container 160, as shown in FIG. 4B. In such embodiments, the sticker may include a peel-away layer, an adhesive layer, an optional backing layer, a carrier layer, one or more compositions including one or more bioactive ingredients, a topcoat layer, and one or more top layers.

In some embodiments, such as shown in FIG. 4C, the sticker 400 may be attached directly to a perishable good (such as a fruit) 170. The perishable good 170 may be contained within a container as shown and described herein, or outside of a container such as shown in FIG. 4C.

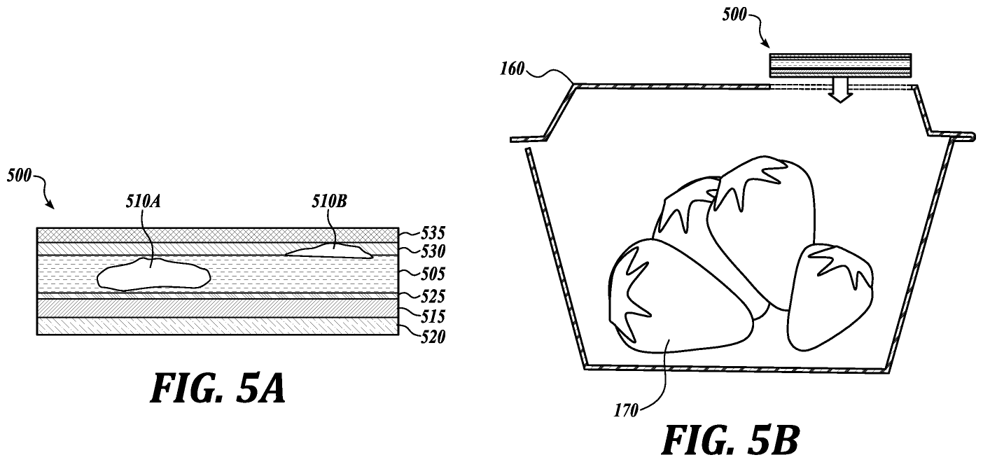

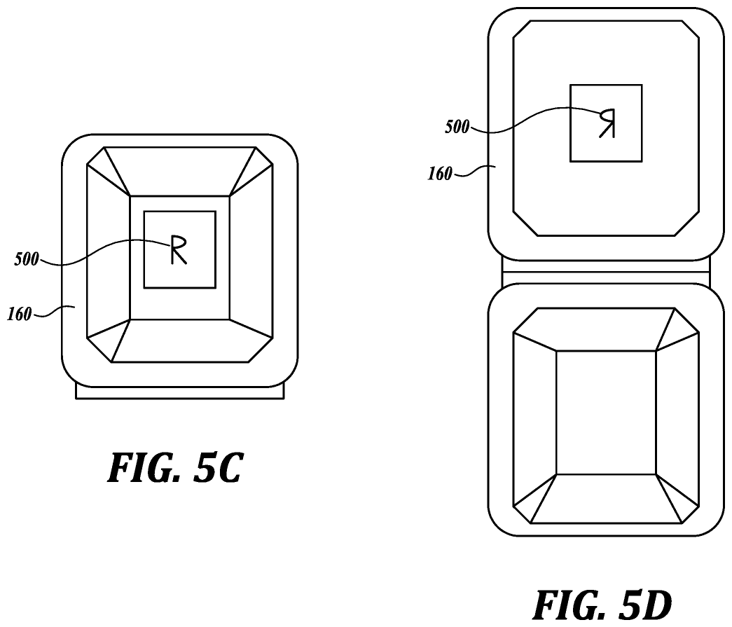

FIGS. 5A-5D are example stickers 500, in accordance with the present disclosure. In some embodiments, the sticker 500 includes an additional one or more top layers 530, 535. In some embodiments, the top layers 530, 535 are highly impermeable to the active compounds 510A, 510B, preventing loss to the atmosphere when the sticker 500 is placed on the outside of the container 160, such as shown in FIG. 5B. In some embodiments, the topcoat layer(s) 530, 535 may also protect the label and active compounds from outside elements such as light, humidity, and oxygen. In some embodiments, the top layers 530, 535 may also be a label, containing an infographic, logo, list of ingredients, a recitation of calories or vitamins in the product, and the like. In some embodiments, the one or more top layers 530, 535 may be formed of mylar, PET, HDPE, metallized plastic film, or a combination thereof.

In operation, the label or sticker 500 is attached to the outside of a container 160. The one or more top layers 530, 535 prevent the bioactive ingredients 510A, 510B from transmitting to the atmosphere, away from the perishable good 170. The adhesive layer 515, and optional backing layer 525 may be permeable to allow transmission of the bioactive compound 510A, 510b into the container. In some embodiments, the container 160 is translucent, as shown in FIGS. 5C-5D. In some embodiments, the label 500 may include writing, images, symbols, logos, or the like, represented by “R” in FIGS. 5C-5D. As shown in FIG. 5D, when the container 160 is translucent, the image, symbol, logo, text, etc. “R” may still be visible through the sticker 500.

In such embodiments, the container 160 may also be permeable. In some embodiments, the container 160 is permeable based on one or more physical openings in the container (e.g., holes or slits configured where the label or sticker 500 attaches to the container). In other embodiments, the container 170 is made of a permeable material, such as cellulose, PLA, polystyrene, or any other materials with adequate permeability to the active compounds.

In some other embodiments, the label 500 can be designed to be placed on the outside of a container 160, such as packaging materials, as shown in FIGS. 5C-5D. In such cases the label 500 is designed to release the active ingredients through the adhesive into the packaging material.

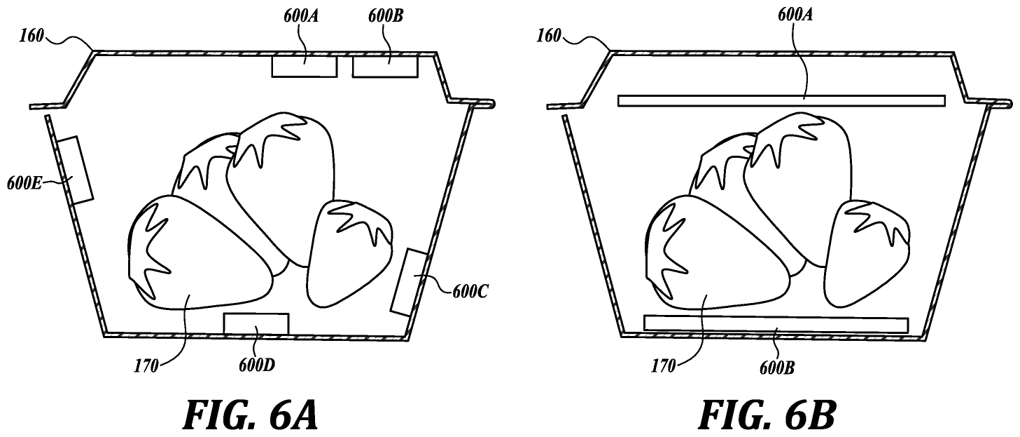

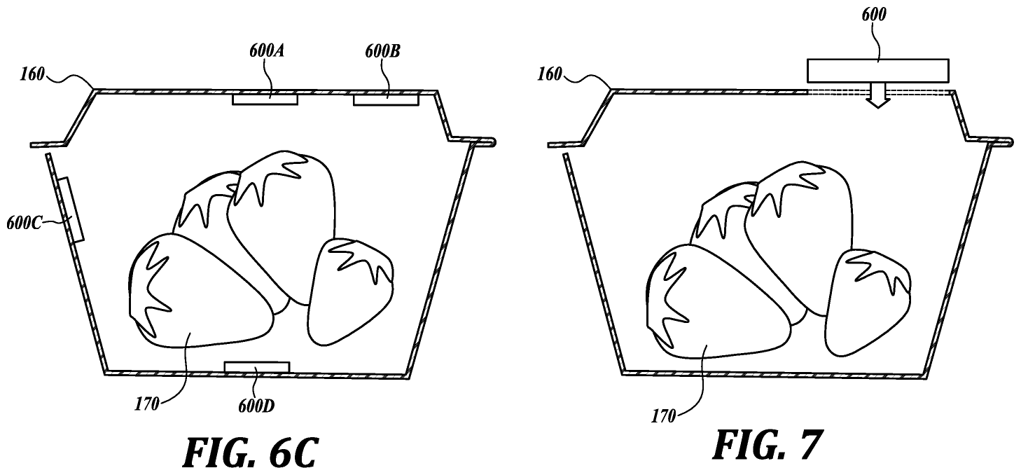

FIGS. 6A-6C are example configurations for products 600, in accordance with the present disclosure. In some embodiments, a plurality of products (sachets, sheets, or labels) 600 are included in a single container. In some embodiments, a single container 160 includes products 600 in the form of a combination of labels, sheets, sachets, or a combination thereof. FIGS. 6A-6C show various configurations that the plurality of products 600 may take inside a container 160.

In each case illustrated above, one or a plurality of products 600 can be placed into each package (container) 160. Sachets 600A, 600B that are stuck to the inside of the packaging in combination with loosely placed sachets 600C, 600D, 600E are shown in FIG. 6A, planar sheets or pads 600A, 600B loosely placed above and below a perishable good 170 are shown in FIG. 6B, and planar labels 600A-600D stuck inside the packaging 160 are shown in FIG. 6C.

FIG. 7 illustrates a configuration of a label 600 where the label 600 is configured to be stuck to the outside of a container 160. In some embodiments, the label 600 is configured to transport active compounds through the packaging material of the container 160 and into it. In some embodiments, the container 160 is permeable through an array of micro-perforations in the container 160. As shown in FIG. 7, in some embodiments, the top surface of the label 600 serves as a diffusion barrier for the active compounds to prevent loss of the compounds into the atmosphere, and is also used as an infographic to provide information about the product or its distributor.

### EXAMPLES

In the case of both the sheet and adhesive label architectures, the bioactive containing composite formulations are coated onto and/or impregnated into a carrier layer. The coating can be, for example, various individual bioactive components by themselves, their combinations, or their composite mixtures with various carrier matrices, or their emulsions dispersed in matrices. These carrier matrices can include beeswax, other waxes, paraffin, hydrogels, oleogels or their mixtures. The coating onto the single layer or a multilayer sheet can be achieved by spray coating, electrospraying, dip coating, gravure coating etc. Sometimes, these carrier+bioactive combinations are applied in a liquid state by elevating the temperature to achieve a molten state which solidifies on the substrate upon cooling. In some other embodiments the bioactives or bioactive+carrier composites can be dissolved in a volatile solvent, such as ethanol, and applied in a liquid state. The solvent is then allowed to evaporate leaving a solid coating on the surface, or substance that has wicked into the porous carrier and solidified in situ upon evaporation of the solvent.

In some embodiments, the bioactives, or the composite carrier+bioactive formulations can also impregnate/diffuse/wick into some layers of the carriers. In this architecture, bioactive components, or composite formulations containing the bioactives and carrier matrices can be infused into or coated onto one or more of the multilayer structure.

In some embodiments, the bioactive compounds or the compositions that contain the bioactive compounds can be directly coated/smeared onto the containers/packaging material. These compositions can be coated onto only portions of the container material or the entirety of it. They can be coated on the inside or outside of the packaging. In some embodiments an additional coating (topcoat) or a film can be applied on top of the composition coating (the functions of such topcoat layer is similar to topcoats discussed before)

In some cases, the bioactive or compositions can be impregnated into the container/packaging material. For example, they can be wicked into a container made of paper/cardboard. The bioactive can also be infused into various plastics used in making these containers.

In all these cases, similar topcoats can be added.

The one or more volatile compound useful in the presently disclosed embodiment may include, but is not limited to, trans-2-hexenal, cuminaldehyde, citronellal, perillaldehyde, thymol, carvacrol, citral, carvone, pulegone, eugenol, bornyl acetate, terpinen-4-ol, linalool, trans-anethole, trans-cinnemaldehyde, methyl eugenol, and essential oils, such as, geranium oil and lavender oil. It is understood by those of ordinary skill in the art that essential oils refer to oils distilled or extracted from plants. Essential oils are not necessarily true oils in the manner of lubricant vegetable oils but are highly fluid and exceptionally volatile. Essential oils may be complex mixtures of different organic molecules, also known as essential oil components or EOCs, monoterpenes, diterpenes, sesquiterpenes, or their oxygenated forms, terpenoids, alcohols, esters, aldehydes, ketones, phenols, thiols, isothiocyanates, and alkaloids, including but not limited to, capsaicinoids. Synthetic oils are usually made from one or more of the constituents predominant within a particular essential oil. For example, menthol often substitutes for mint and eucalyptol for eucalyptus. Further, the chemical composition of an essential oil may vary depending on time of day, the month or season the essential oil is harvested, environmental conditions leading up to and including the essential oil harvest, the means for extracting the essential oil, and for synthetic oils the chemical composition may vary from batch to batch. The environmental conditions leading up to and including the essential oil harvest include, but are not limited to, drought, excessive precipitation, and the like.

Both synthetic essential oils and naturally occurring essential oils may be used for fragrant, medicinal, antiseptic, solvents, and insecticidal purposes. For example, essential oils, such as methyl salicylate or thymol are impregnated into water insoluble resins and may be used to disseminate a fragrance or medicinal vapor into a room. Typical essential oils are obtained from thyme, lemongrass, citrus, anise, clove, aniseed, roses, lavender, citronella, eucalyptus, peppermint, camphor, sandalwood, cinnamon leaf, cedar, almond, grapes, walnut, jojoba, olives, and the like. In some embodiments, the essential oil may also be derived from nuts or seeds. Essential oils are generally liquid at room temperature (20 C-25 C). The essential oils suitable for the present disclosure are typically commercially available and preferably refined. However, in some embodiments, synthetic essential oils may be used. One or more essential oil component may be present in each essential oil.

Essential oil components useful in the presently disclosed and claimed inventive concept may include, but are not limited to, (−)-bornyl acetate, (−)-terpinen-4-ol, (+)-carvone, (+)-citronellal, (R)-(+)-citronellal, (S)-(−)-citronellal, (R)-(+)-pulegone, 4-allylanisole, carvacrol, cis-3,7-dimethyl-2,6-octadien-1-ol, citral, citronellol, eugenol, linalool, methyl eugenol, methyl trans cinnamate, myrcene, thymol, trans-anethole, trans-cinnamaldehyde, terpineol (mixture of isomers), 1-methyl-3-methoxy-4-isopropylbenzene, menthol, menthone, isomenthone, geranyl formate, palmitic acid, 4-isopropylbenzaldehyde (also known as cuminaldehyde), trans-2-hexenal, (S)-(−)-perillaldehyde, nootkatone, geranium oil, and lavender oil.

The one or more plant immune-stimulatory compound may include pinene, camphene, terpinene, terpineol, chitosan, methyl jasmonate, and methyl salicylic acid, ethyl salicylic acid, methyl cinnamic acid, β-aminobutyric acid, fructans (inulin, levan), ethylene, harpin proteins, jasmonic acid, and the like. The one or more plant immune-stimulatory compounds refers to compounds that do not directly affect a disease-causing organism, nor alter the DNA of the treated perishable good (except for in the case of altering the expression of various genes by up or down regulating them), but instead activate a natural defense mechanism in the perishable good. It is understood to those of ordinary skill in the art that plant immune-stimulatory compound may also be referred to as a plant activator.

Examples of the one or more non-volatile compound may include, but are not limited to, curcumin, chitosan, phytoalexins, phytoanticipin, one or more preservative, and one or more antioxidant, including but not limited to, Vitamin E, Vitamin A, Vitamin C, beta carotene, butylated hydroxyanisole (BHA), butylated hydroxytoluene (BHT), or UV protectants such as titanium dioxide. The one or more non-volatile compounds may have a microbicidal effect, an immune stimulatory effect, and/or may prevent or slow the oxidation process in the perishable good. The microbicidal effect may reduce the infectivity of microbes, such as bacteria or fungi, which may have a spoilage effect on the perishable good. In one embodiment, the composition comprising the protective coating, one or more volatile compound, and one or more non-volatile compound may create a synergistic effect of an increased reduction in perishable good loss compared to the perishable good loss of the individual components. In some embodiments, the two or more bioactive compounds can be included that complement one another or broaden the action spectrum. In another embodiment, a lower concentration of the one or more volatile compound and one or more non-volatile compound in composition with the protective coating may achieve the desired biological result faster than a higher concentration of the one or more volatile compound and one or more non-volatile compound not in composition with a protective coating. In another embodiment, the addition of the one or more antioxidant and or the one or more preservative in the transmission system may help to retain the efficacy of the bioactive formulations of the composition.

The one or more ethylene actor compounds that are useful in the presently disclosed and claimed inventive concept may include, but are not limited to, norbornadiene, resveratrol, sodium permanganate, potassium permanganate, vanillin, activated carbon, and 1-methylcyclopropene. The one or more ethylene actor compounds refer to ethylene absorbing/adsorbing compounds and compounds which inhibit ethylene production or reduce the sensitivity to ethylene in the perishable good. An example of a volatile ethylene antagonist is 1-methylcyclopropene (1-MCP). 1-MCP binds to a plurality of ethylene receptors of the agricultural product and blocks the recognition of ethylene by the plurality of ethylene receptors. The blocking of recognition of ethylene by the plurality of ethylene receptors of the perishable good tends to reduce the effect of ethylene triggering a ripening response of the perishable good. The blocking of plurality of ethylene receptors of the perishable good also reduces autocatalytic production of ethylene. 1-MCP may reduce ethylene production and de-sensitize the perishable good to ethylene.

In some embodiments, the one or more transmission systems comprise one or more compositions having one or more active compound and a carrier. The carrier may be in a solid, semi-solid, liquid, or gaseous state. The carrier may act as a medium and/or as a diffusion retardant to stabilize/hold the one or more active compound to regulate the release rate of the one or more active compound from the carrier into the environment. The carrier may be selected from a group consisting of water, paraffin, petroleum-derived wax, beeswax, plant-derived wax, rice bran wax, resin, synthetic polymer, biodegradable natural polymer, oils and fats, ceramic compounds, one or more inorganic compound, macrocycles, such as cyclodextrins, surfactants, clays, fibers, fiber-like material, paper, and metal-organic frameworks (MOFs). Macrocycles include cyclodextrins and other similar compounds having a cage-like structure. The biodegradable natural polymer may be derived from natural plant or animal material, ceramic or inorganic compounds. In some embodiments, the carrier may be made of paraffins, wax, natural rubber, synthetic rubbers, shellac, cellulose composites, semipermeable plastics, including but not limited to polyisoprene, polybutadiene, nylons (polyamides), polyurethanes, low-density polyethylene (LPDE), high density polyethylene (HDPE), perforated plastic films, polyethylene terephthalate (PET), polystyrene (PS), polylactic acid (PLA), polycarbonate (PC), polypropylene (PP), polycaprolactone (PCL), polyvinyl alcohol (PVA), ethylene vinyl alcohol (EVOH), polyvinyl acetate (PVAc), polyacrylic acid (PAA), polyethylene oxide (PEO), perforated or patterned metalized plastic films, where the unmetallized parts are permeable to the active compounds, sponges, porous materials, and combinations thereof.

In some embodiments, the carrier may take any number of structures. In some embodiments, the structure may be a wax, crystalline, resin, or oleogel structure. For example, if the carrier is a wax or oil structure, the carrier may be formed of animal waxes (natural mixtures of wax esters and sterol esters like beeswax or lanolin), plant waxes (natural mixtures of alkanes, wax esters, fatty acids, fatty alcohols, phytosterols like carnauba wax, candelilla wax, bayberry wax, soy wax, natural/vegetable oils (mixtures of natural triglycerides or processed natural triglycerides like canola oil, grapeseed oil, avocado oil, walnut oil, coconut oil, soybean oil, palm oil, hydrogenated oils), petroleum oils and waxes (mixtures of alkanes like paraffin oil, paraffin wax, microcrystalline wax), and combinations thereof. In some embodiments, when the carrier is a crystalline structure, the carrier may be formed of fatty acids (lauric acid, palmitic acid, stearic acid, oleic acid, etc.), fatty acid salts (sodium palmitate, potassium palmitate, sodium stearate, calcium stearate, etc.), fatty alcohols (cetyl alcohol, cetearyl alcohol, etc.), and combinations thereof. In a resin structure, the carrier may be formed from natural resin or rosin, modified resins, and mixtures of resin acids like Pine resin or rosin, mastic rosin, and dammar rosin, hydrogenated pine rosin, glycerol ester of pine rosin, and mixtures thereof. In an example where the carrier is in an oleogel structure, the carrier may include combinations of waxes, and/or oils, and/or crystals, and/or resins that form a solid, gel, cream, or viscous liquid. In some embodiments, the ratios of components will adjust mechanical properties of the carrier.

In some embodiments, the carrier may have a hydrogel or gum structure, a plastic structure, or a porous solid structure. In a hydrogel or gum structure, the carrier may include collagen/gelatin, silk, gluten, zein, caseins, keratin (like wool), soy protein, pea protein, sunflower protein, polysaccharides such as cellulose, modified celluloses (such as methyl cellulose, ethyl cellulose, hydroxypropyl cellulose, etc), pectin, chitosan, chitin, alginate, starch, carrageenan, agar, shellac, hyaluronic acid, gums including xanthan gum, gum Arabic, guar gum, locust bean gum, mastic, gellan gum, spruce gum, and combinations thereof. In some embodiments, the plastic structure may include polystyrene (PS), polypropylene (PP), polyethylene (PE, LDPE, HDPE), poly lactic acid (PLA), polycaprolactone (PCL), polyethylene terephthalate (PET, PETE), methyl cellulose (MC), ethyl cellulose (EC), hydroxypropyl methyl cellulose (HPMC), and combinations thereof. In porous solid structures, the carrier may include activated carbon, porous oxides (silica, alumina, titania), porous concrete mixtures, zeolites, clays, such as bentonite and montmorillonite, paper, cellulose sponge, felts, such as cellulose felt, cork, glass fiber paper, sponges such as PP sponge and PE sponge, and combinations thereof.

In some embodiments, the carrier includes a solvent or thinning agent, such as ethanol, glycerol, water, salt solution in water, such as sodium chloride, potassium chloride, calcium chloride, magnesium chloride, calcium carbonate, and mixtures thereof. In some embodiments, the carrier includes an emulsifier or a wetting agent. In some embodiments, the emulsifier or wetting agent is selected from fatty acids (lauric acid, palmitic acid, stearic acid, oleic acid, etc.), fatty acid salts (sodium palmitate, potassium palmitate, sodium stearate, calcium stearate, etc.), fatty alcohols (cetyl alcohol, cetearyl alcohol, etc.), monoglycerides (glycerol monostearate, glycerol monopalmitate, etc.), diglycerides (glycerol distearate, glycerol dipalmitate, etc.), lecithins/phospholipids (egg lecithin, soy lecithin, or sunflower lecithin), sterols (phytosterol, cholesterol, etc.), sorbitans (sorbitan laurate, sorbitan stearate, etc.), polysorbates (polyoxyethylene sorbitan laurate, polyoxyethylene sorbitan stearate, etc.), polyethylene ethers (polyethylene lauryl ether, polyethylene cetyl ether, etc.), sulfate surfactants (sodium octyl sulfate, sodium dodecyl sulfate, etc.), quaternary ammonium surfactants (cetrimonium chloride, behentrimonium chloride), and combinations thereof.

In some embodiments, the carrier can be shaped as beads or spheres, spheroids, ovoids, dollops, small pancake like shapes, short rods/cylinder shapes, unevenly shaped granules, planar films, thick planar layers, thick layers with patterned surfaces (such as honeycomb shaped), powders dispersed in another matrix (e.g., fine powder or small granules containing active compounds mixed into a wax or paraffin as an inclusion, where the resulting wax with inclusions is shaped into a physical embodiment as described herein).

The release rate altering mechanism of the transmission system may include one or more diffusion barriers. The one or more diffusion barriers may be applied to the composition to slow the overall release rate of the one or more active compound into the environment adjacent the perishable good. The permeability of the one or more diffusion layers may be affected by the material of the one or more diffusion barriers and/or the thickness of one or more diffusion barriers. In one embodiment, the permeability of the diffusion barrier may be altered in response to changes in temperature and humidity. Similarly, oil droplets having one or more active compound may be suspended in the carrier that is environmentally dependent, such as a polymer matrix. For example, in another embodiment, the one or more diffusion barrier may be positioned adjacent one or more carrier comprising one or more composition having the active compound to modify the release rate of the composition into the environment of the perishable goods. In another embodiment, the one or more diffusion barrier may have a second or third composition having one or more active compound. The one or more diffusion barrier having the second or third composition having one or more active compound may slow the release rate of the one or more active compound and/or the second or third active compound into the environment adjacent the perishable goods.

In another embodiment, the release rate altering mechanisms may be based upon the structure of the composition and the form of the carrier. The structure of the composition may include macroscopic, mesoscopic, and microscopic geometries, such as beads or granules of various sizes; small pellets with specified sizes and aspect ratios; honeycomb structures, and other multilayer constructions of the composition. The form of the carrier, for example, may also include various amounts of porosities. The macroscopic, mesoscopic, and microscopic geometries of the structure of the composition and the form of the carrier may affect the transfer and release rate of the composition into the environment of the perishable good. In one embodiment, the quantity of the one or more active compound within the composition and the structure of the composition affects the release rate of the composition into the environment of the one or more perishable good. In another embodiment, the release rate of the one or more active compound may be affected by proportion of the amount of the active compound within the composition versus the volume of the composition based on the structure of the composition and the form of the carrier. For example, the porosity of the carrier may affect the transport of the composition within the transport system. In another embodiment, the structure of the composition and/or the form of the carrier may be combined in one transmission system to achieve highly complex release profiles. For example, a transmission system comprising one or more composition comprising one or more active ingredient and one or more carrier formed into one or more shape suitable for releasing the composition into the environment of the perishable goods at a rapid release rate, whereas a transmission system comprising one or more composition having one or more carrier formed into one or more shape may release the composition into the environment of the perishable goods at a slower release rate.

In one embodiment, the form of the carrier may be porous. Examples of carriers being porous include, but are not limited to include mesoporous Silica, anodized Aluminum, sponges, foams, compressed cellulose matrices (papers), and various polymers, etc. The porous carriers may vary the porosity, pore size distribution, tortuosity, and transport properties of the one or more composition of the transmission system. In one embodiment, the one or more composition may be positioned within one or more pore of the porous structure. In another embodiment, the one or more composition may be combined with a carrier and the carrier may be positioned within the one or more pore of the porous structure. By way of example, but in no way limiting, one or more compositions in combination with a carrier comprising beeswax may be positioned within the one or more pore of a porous carrier comprising a mesoporous material.

In another embodiment, microscopic morphology of the carrier may have the structure of the carrier as microporous. The one or more active compounds are released into the environment via the microporous structure (“pores”) of the carrier. The pores have a space devoid of any material, or may contain one or more other materials, including one or more active compound in any physical state. In one embodiment, the pores may be singular; i.e., one pore surrounded by the carrier from all sides. In another embodiment, the pores may be two or more; i.e., two or more pores may be surrounded by the carrier. In another embodiment, the network of pores may be physically connected providing one or more pore pathway positioned within the carrier. In one embodiment, the one or more pore pathway may be positioned adjacent environment surrounding the perishable good. Examples of the carrier having a microporous structure include but are not limited to mesoporous silica nanoparticles, microporous alumina, and anodized aluminum having an anodization layer. Mesoporous silica nanoparticles have unique characteristics such as an orderly arrangement of pores, biocompatibility, and may be used as a control release mechanism. The mesoporous silica nanoparticles may be incorporated into other matrices such as packaging and wax to further influence control release characteristics. Characteristics of pores in these materials may be controlled so as to yield the desired controlled release characteristics. One or more surface of the mesoporous silica particle carrier and the microporous alumina carrier may also be chemically modified to change the hydrophilicity, the hydrophobicity, or directly hold the compound by chemically attaching cyclodextrins to the compound. In one embodiment, the carrier may be modified by a molecular nanoimprinting process. The molecular nanoimprinting process imprints a resin with a molecule while the compound sets to makes the pores of the carrier molecule-specific.

In another embodiment, the structure of the composition may have a particle configuration of a powder, granule, or the like. A plurality of particle configurations may be altered into a desired macroscopic shape such as a tablet, ball, disc, or the like. In one embodiment, the macroscopic shape may be optimized to achieve a certain level of porosity between the powder/granules. The process of forming the macroscopic shape determines the surface to volume ratio of an individual particle configuration as well as macroscopic shape of the plurality of particle configurations. In another embodiment, the plurality of particle configurations may also be formed into a macroscopic shape having one or more pore. The one or more pore of the macroscopic shape may be impregnated, or back-filled with a substance such as a resin, hydrogel, viscous liquid, or the like. The substance may serve as a barrier affecting the release rate of the one or more active compound from the one or more pore of the macroscopic shape. In another embodiment, the one or more pore may be inert and serve as a scaffold. The one or more pore serving as a scaffold have a diffusion retarding matrix positioned within the one or more pore. In another embodiment, the one or more pore serving as a scaffold may degrade and be removed during processing (similar to a lost wax process) resulting in a 3D porous network of the diffusion retarding matrix. In one embodiment, one or more composition may be a plurality of bead particle configurations varying in size. The plurality of bead particle configurations having a smaller size have a higher surface-to-volume ratio. The plurality of bead particle configurations having a smaller size will have a faster release rate for releasing the one or more active compound to reach a target gas concentration. The plurality of bead particle configurations having a smaller size will dispense of the one or more composition at a faster rate. The plurality of bead particle configurations having a larger size, as such having a smaller surface-to-volume ratio, may maintain a target concentration over a longer period of time. In another embodiment, the plurality of bead particle configurations may be coated with the one or more diffusion barrier. The one or more diffusion barrier may slow down the release rate. In some embodiments, the plurality of beads can range in size from 1 micron to 1 centimeter in diameter. It should be understood that this diameter is the diameter of a similarly sized sphere when the carrier is an irregularly shaped granule. In some embodiments, the thickness of the carrier may range from 1 micron to 1 centimeter.

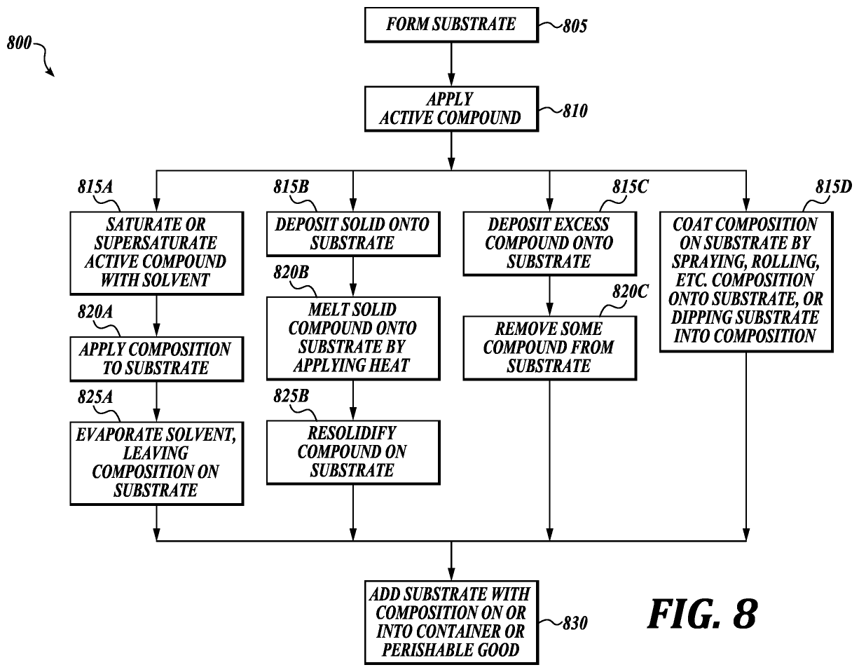

FIG. 8 is a flowchart of a method 800 of manufacturing the products (sachets, sheets, stickers, and labels) as described herein. In a different embodiment, the method 800 may include additional steps or may omit some of the illustrated steps In some embodiments, the products may include sachets 100, sachets 200, sheets 300, stickers/labels 400, stickers/labels 500, products 600, or a combination thereof, as described herein.

In some embodiments, in block 805, a substrate is formed. In some embodiments, the substrate may be the substrate described in FIG. 3A. In other embodiments, the substrate is the carrier layer in FIGS. 4A-4B.

In block 810, the active compound (bioactive compound) is applied to the substrate. Though four methods 815A, 815B, 815C, 815D of applying the compound to the substrate are illustrated, any suitable method of applying the compound to the substrate may be utilized. In some embodiments, the active compound or bioactive compound, is compound 110, 210, 310, 410, 510, or a combination thereof.

In one embodiment, in block 815A, the active compound is dissolved in a solvent below the saturation limit, or saturated or super saturated with a solvent, such as ethanol. In block 820A, once dissolved, saturated or super saturated, the mixture of active compounds and solvent may be applied to the substrate. In block 825S, the solvent may then be evaporated, leaving the active compound on the substrate.

In another embodiment, in block 815B, a solid is deposited onto the substrate. In some embodiments, the solid is a bioactive ingredient mixed with a carrier material as described herein. In some embodiments, in block 820B, the solid is melted onto the substrate by applying heat. In block 825B, the melted solid then resolidifies onto (or inside, such as when the active compound permeates the substrate) the substrate.

In some embodiments, in block 815C, an excess of active compound is applied onto the substrate. In block 820C, a portion of the excess active compound may then be removed, such as by wiping.

Finally, in some embodiments, in block 815D, the active compound is coated onto the substrate, either alone or in combination with a carrier material as described herein. In some embodiments, the active compound is coated by spraying, rolling, or the like the active compound onto the substrate. In some embodiments, the active compound is coated by dipping the substrate into the active compound.

In some embodiments, a combination of some or all of the methods 815A, 8156B, 815C, 815D of applying the active compound are utilized.

Optionally, additional layers may then be added to the substrate to form a sheet or sticker as described herein, including a backing layer, an adhesive layer, a peel away layer, a topcoat layer, a top layer, or a combination thereof.

In block 830, the substrate with the composition are added on or into a container, or onto a perishable good (such as perishable good 160),

It is understood of those of ordinary skill in the art that the present disclosure may also be applicable to various items including but not limited to food, fibers, implements, household cleaning products, healthcare environments, and construction surfaces to preserve their integrity and prevent the presence of various fungi, molds, and other microorganisms. Such compositions can also be applied to building structures, plant parts, and even clothing items for their preservation.

The ideas presented here can also be broadened to many other application areas beyond preservation of perishable goods. For example, other food products such as aged cheese, cured meats, etc., which may be susceptible to spoilage, can be protected with these technologies. Furthermore, as the volatile antimicrobial active compounds often have species-or strain-level specificity of action spectrum, the volatile antimicrobial active compounds can be chosen among those that do not have a suppressing effect on the growth of desirable organisms (e.g. in moldy cheeses, such as Roquefort or Camembert cheeses) while suppressing the spoilage-causing organisms.

Other applications may include (1) environmental sanitation; for example but in no way limited to, household cleaning solutions that are safe, natural, and not require spatial precision; (2) healthcare applications, for example but in no way limiting, forming a biofilm on medical devices that come into direct contact with people, such as by forming a biofilm inhibition solution that can function at a distance; (3) other industries that have recurring issues with fungal or bacterial growth such as leather production; for example, veterinary services.

1. A sachet for preventing spoilage of a perishable good comprising:
one or more composites, wherein each composite of the one or more composites comprises one or more bioactive compounds and a carrier material; and
a transmitting layer configured to enclose the composite and allow transmission of the one or more bioactive compounds.

2-10. (canceled)

11. A sheet for preventing spoilage of a perishable good comprising:
one or more composites, wherein each composite of the one or more composites comprises one or more bioactive compounds and a carrier material; and
a substrate configured to hold the composite,
wherein the sheet is configured to transmit the one or more bioactive compounds onto the perishable good.

12. The sheet of claim 11, wherein the one or more composites is coated onto the substrate.

13. The sheet of claim 11, wherein the one or more composites at least partially impregnate the substrate.

14. The sheet of claim 11, wherein the one or more bioactive compounds are selected from a group consisting of trans-2-hexenal, trans-2-octenal, trans-2-nonenal, trans-2-decenal, trans-2-dodecenal, cuminaldehyde, citronellal, thymol, perillaldehyde, carvacrol, citral, carvone, pulegone, eugenol, bornyl acetate, 1-octanol, terpinen-4-ol, linalool, trans-anethole, trans-cinnamaldehyde, ethyl octanoate, ethyl nonanoate, ethyl decanoate, methyl octanoate, methyl nonanoate, methyl decanoate, fenchol, borneol, camphor, methyl eugenol, menthol, methyl salicylate, methyl anthranilate, methyl jasmonate, phenylethyl acetate, phenylacetic acid, cinnamic acetate, gamma-octalactone, gamma-decalactone, eucalyptol, farnesol, geraniol, furaneol, geranium oil, lavender oil, thyme oil, clove oil, (−)-bornyl acetate, (−)-terpinen-4-ol, (+)-carvone, (+)-citronellal, (R)-(+)-citronellal, (S)-(−)-citronellal, (R)-(+)-pulegone, thymol, 4-allylanisole, cis-3,7-dimethyl-2,6-octadien-1-ol (nerol), citronellol, methyl trans cinnamate, myrcene, ocimene, terpineol, 1-methyl-3-methoxy-4-isopropylbenzene, menthol, menthone, isomenthone, vanillin, geranyl formate, palmitic acid, (S)-(−)-perillaldehyde, nootkatone, hinokitiol, d-limonene, s-limonene, p-cymene, terpinene, nerolidol, 3-decen-2-one, ionone, damascenone, and other stereoisomers of these compounds, and combinations thereof.

15. The sheet of claim 11, wherein the carrier material is selected group consisting of water, paraffin, petroleum, natural waxes, sunflower wax, carnauba wax, rice bran wax, candelilla wax, beeswax, resin, synthetic polymer, biodegradable natural polymer, ceramic, modified cellulose, methyl cellulose, surfactants, mesoporous silica nanoparticles, microporous alumina, anodized aluminum, activated carbon, zeolites, metal carboxylates, inorganic compounds, and combinations thereof.

16. The sheet of claim 11, wherein the sheet further comprises:
an adhesive layer configured to secure the sheet to a container; and
a peel-away layer configured to be removed from the adhesive layer to expose the adhesive layer.

17. The sheet of claim 16, wherein the adhesive layer is mixed or infused with the one or more bioactive compounds.

18. The sheet of claim 11, wherein the sheet further comprises:
a peel-away layer configured to be removed from the sheet to allow the release of the one or more bioactive compounds.

19. The sheet of claim 11, wherein the sheet further comprises a topcoat layer configured to adjust a release rate of the one or more bioactive compounds.

20. The sheet of claim 19, wherein the topcoat layer further comprises the one or more bioactive compounds.

21. The sheet of claim 16, wherein the sheet is configured to be secured to an outside surface of the container.

22. The sheet of claim 11, wherein the sheet further comprises at least one topcoat configured to prevent loss of the one or more bioactive compounds into environment.

23. The sheet of claim 22, wherein the at least one topcoat comprises an image, infographic, text, or a combination thereof.

24. The sheet of claim 23, wherein the image, infographic, text, or a combination thereof is a separate layer on top of the at least one topcoat.

25. (canceled)

26. A system for preventing spoilage of a perishable good, the system comprising:
the sheet according to claim 11; and
a container configured to hold the perishable good, wherein the sheet is placed proximate to the container and configured to release the one or more bioactive compound into the container and onto the perishable good.

27. A system for preventing spoilage of a perishable good, the system comprising:
the sheet according to claim 19; and
a permeable container,
wherein the sheet is placed on an outside surface of the permeable container, and wherein the sheet is configured to release the one or more bioactive compounds through the permeable container and onto the perishable good.

28. A spoilage preventing product for preventing spoilage of a perishable good, the spoilage preventing product comprising:
one or more composites, wherein each composite of the one or more composites comprises one or more bioactive compounds and a carrier material; and
a transmitting layer configured to enclose the composite and allow transmission of the one or more bioactive compounds.

29. The sheet of claim 11, wherein the one or more composites are sandwiched between layers of the sheet.

30. The sheet of claim 11, wherein the sheet further comprises:
one or more capping layers, wherein the one or more capping layers are located on a top plane and a bottom plane of the sheet.
